(19) United States
(12) Patent Application Publication
(10) Pub. No.: US 2005/0179214 A1
(43) Pub. Date: Aug. 18, 2005

(54) Bushing arrangement for sealing passage of a cable, a pipe, a conduit or the like through an opening in a wall

(76) Inventor: Johannes Alfred Beele, Aalten (NL)

Correspondence Address: William B Patterson;Moser Patterson & Sheridan, Suite 1500, 3040 Post Oak Boulevard, Houston, TX, 77056, US

(21) Appl. No.: 10/504,016

(22) PCT Filed: Jan. 30, 2003
(86) PCT No.: PCT/NL03/00067

(30) Foreign Application Priority Data
Feb. 7, 2002 (NL) 1019919

(51) Int. Cl. F16J 3/00

(52) U.S. Cl. 277/628

(57) ABSTRACT

A bushing arrangement for sealing passage of a cable, a pipe, a conduit or the like through an opening in a wall, which bushing arrangement comprises at least one seal arranged in the opening in the operative condition, which seal is at least substantially made of an elastic, fire resistant material with a base of a cross-linkable polymer and an expandable agent in a quantity and composition such that the seal will expand in case of a fire, in such a manner that the opening on the wall will be sealed medium-tight, a special feature being the fact that the material of the seal has a foam structure comprising closed cells.

The invention relates to a bushing arrangement for sealing passage of a cable, a pipe, a conduit or the like through an opening in a wall, which bushing arrangement comprises at least one seal arranged in the opening in the operative condition, which seal is at least substantially made of an elastic, fire-resistant material with a base of a cross-linkable polymer and an expandable agent in a quantity and composition such that the seal will expand in case of a fire, in such a manner that the opening in the wall will be sealed medium-tight. It is noted that the term “wall” in this connection is understood to mean any partition between two spaces, and consequently also includes a ship's deck, a bulkhead or the like.

Such a bushing arrangement is generally known. In the known bushing arrangement, the fire-resistant material of the seal contains an expandable agent which will expand upon exposure to a high temperature caused by fire, so that the seal will permanently seal the opening in the wall surrounding the cable, pipe, conduit or the like being passed therethrough in order to prevent gases and/or liquids moving through said opening from one side of the wall to the other side of the wall. In case of a fire, the bushed cable, pipe, conduit and the like will usually deform, for example as a result of plasticising, and the seal will expand in such a manner that an effective sealing of the opening in the wall will be maintained in that case.

One drawback of the known bushing arrangement is the fact that the fire-resistant material of the seal will absorb fire extinguishing water, for example, in case of a fire, which has an adverse effect on the sealing action of the seal, with all its harmful consequences as regards undesirable transport of gases and/or liquids from one side of the wall to the other side. Another drawback of the known bushing arrangement is the fact that in case of a fire on one side of the wall, the temperature on the other side of the wall will run up (too) high. This may cause objects present on said other side of the wall to take fire, as a consequence of which the fire will propagate from one side of the wall to the other side.

The object of the invention is to overcome the aforesaid drawbacks of the prior art, and in order to accomplish that objective a bushing arrangement of the kind referred to in the introduction is according to the invention characterized in that the material of the seal has a foam structure comprising closed cells. Surprisingly, it has become apparent in practice that said closed cells provide an excellent thermal insulation, owing to the presence of trapped air in the closed cells. Said air inclusions thus prevent the temperature on the side of the wall remote from the fire from running up so high as to constitute a fire hazard. The closed cells cannot absorb any fire extinguishing water, so that the effectiveness of the seal will remain unchanged.

In one preferred embodiment of a bushing arrangement according to the invention the cross-linkable polymer is composed of at least a rubbery linear polymer, preferably a terpolymer of ethylene, propylene and a third monomer containing two double carbon-carbon bonds (diene), with sulphur being the vulcanisation agent. The cross-linkable polymer may be acidic (PH<7) or basic (PH>7) in that case. In another preferred variant, the cross-linkable polymer is composed of at least a rubbery linear polymer, preferably a copolymer of ethylene and vinyl acetate, with carbon peroxide sides being the vulcanisation agent. Research has shown surprisingly shown that vulcanisation can take place optimally if the cross-linkable polymer is basic.

In another preferred embodiment of a bushing arrangement according to the invention the cross-linkable polymer is composed of at least a rubbery linear polymer containing 10-20 wt. % of ammonium polyphosphate. Ammonium polyphosphate is very suitable for use as a fire-resistant/flame-extinguishing material, since it does not have an adverse effect on the properties of the rubber material. As is known, rubber is very sensitive to additives as regards its resistance against ozone, (high) temperatures, ageing, ultraviolet light etc.

In another preferred embodiment of a bushing arrangement according to the invention the expandable agent contains graphite in an amount of 5-25 wt. %. In particular, said expandable agent contains graphite in an amount of 10-15 wt. %, preferably about 12.5 wt. %. This composition provides a proper sealing effect at usual temperatures of 15-50 degrees Celsius as well as a suitable expansion at higher temperatures, e.g. temperatures upwards of 50 degrees Celsius.

In another preferred embodiment of a bushing arrangement according to the invention the seal is made up of sheet material.

In another preferred embodiment of a bushing arrangement according to the invention the seal is made up of several hose members arranged in the opening in the wall. Said hose members may or may not be massive, or form sleeve means through each of which a cable, a pipe, a conduit or the like extends for the purpose of being passed through the opening in the wall. In the latter case, the remaining space in the opening in the wall is filled up with massive hose members and/or with hose members forming sleeve means.

The invention also relates to a method for sealingly passing a cable, a pipe, a conduit and the like through an opening in the wall, in which a seal is arranged in the opening in the operative condition, which seal is at least substantially made of an elastic, fire-resistant material with a base of a cross-linkable polymer and an expandable agent in a quantity and composition such that the seal will expand in case of a fire, in such a manner that the opening in the wall will be sealed medium-tight, characterized in that the material of the seal is given a foam structure comprising closed cells.

Finally, the invention relates to a seal as such in the form of sheet material or hose members.

The invention will now be explained in more detail with reference to figures illustrated in a drawing, in which:

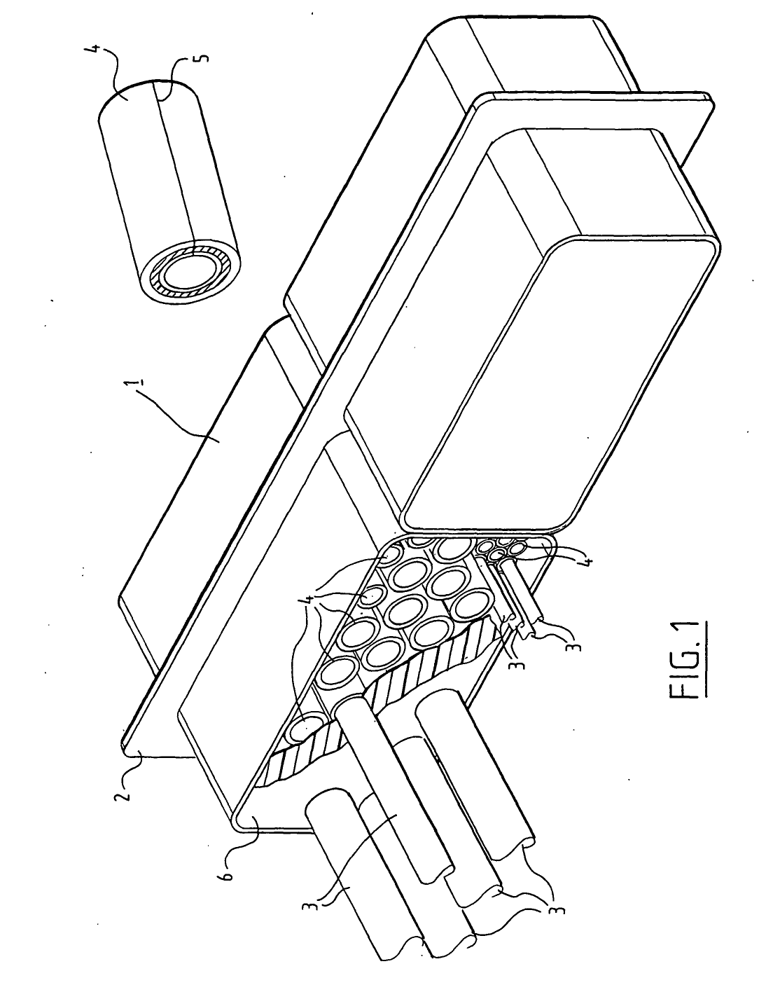

FIG. 1 relates to a bushing arrangement according to the invention in a first embodiment thereof, showing a schematic and perspective view of a seal in the form of hose members;

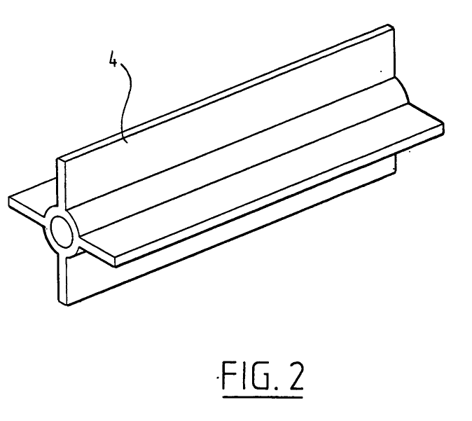

FIG. 2 is a schematic, perspective view of another variant of a hose member; and

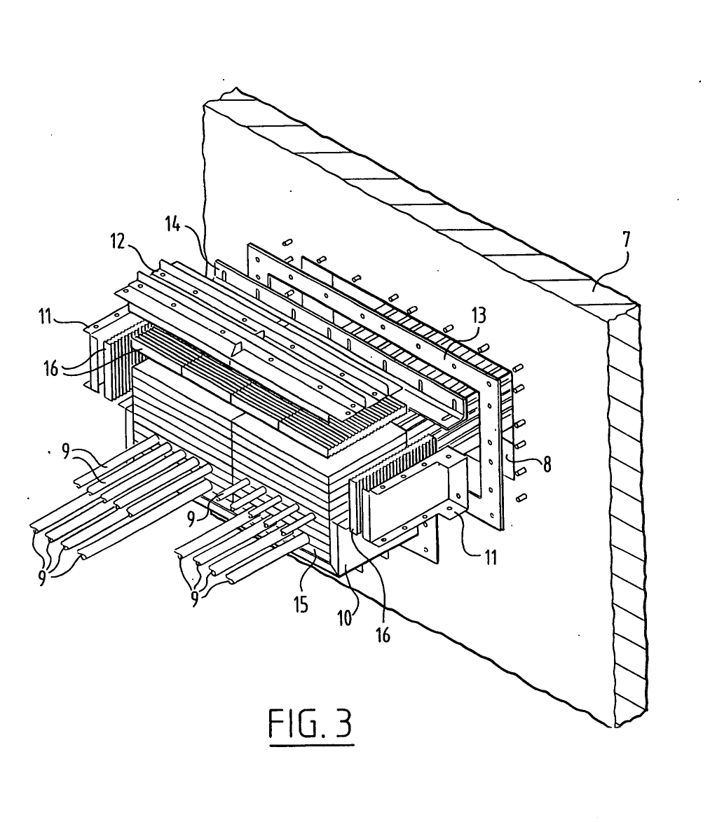

FIG. 3 shows a second embodiment is of a bushing arrangement according to the invention, in which the seal is in the form of sheet material.

FIG. 1 shows a frame (1) which can be mounted in an opening formed in a steel deck or bulkhead of a ship. The frame (1) comprises a flange (2) which lies in the plane of the steel deck, which flange (2) functions to support the frame.

After the frame (1) has been sealingly fitted in the opening, electric lines (3) are drawn through the frame (1). Subsequently, a hose member or sleeve (4) made of a fire-resistant rubber is fitted round each electric line (3). Said fitting can be effected more easily if the hose members or sleeves (4) are provided with a continuous slit (5). Following that, the remaining space in the frame (1) is filled, likewise with sleeves (4) of the same fire-resistant rubber. Finally, a heat-resistant and/or liquid-repellent material (6) is applied to both open sides of the frame. Said material (6) has been selected to have good adhesive properties and to vulcanise with the moisture in the air to form a rubbery material within 24 hours. The outer surface of the heat-resistant and/or liquid-repellent material (6) may be smoothed with a wet knife. The heat-resistant and/or liquid-repellent material (6) ensures a liquid-tight and gastight bushing of the electric lines (3). It is precisely because the heat-resistant and/or liquid-repellent material (6) is present between and in the sleeves (4) functioning as fillers and between the sleeves (4) surrounding the electric lines (3) that a very stable whole having a great adhesive capacity is obtained. It is noted that the heat-resistant and/or liquid-repellent material (6) is partially left out in FIG. 1, and that the right-hand opening in the frame (1) is shown to be empty so as not to complicate FIG. 1 unnecessarily.

In another preferred variant, hose members (4), which may or may not be massive, may be used instead of sleeves (4), which hose members will be arranged round the bushed cable (3) in the frame (1) in that case. The cable (3) is surrounded by the hose members (4), which may or may not be massive, and supported by the lower hose members in the frame (1). The latter hose members (4) are in particular star-shaped, seen in cross-sectional view; such a hose member is shown in FIG. 2. As already explained above, a cable (3) is not passed through the hose member shown in FIG. 2, but such hose members (4) are grouped around one or more cables (3) in the frame (1). Said hose members (4) fill up the remaining space in the frame (1), whilst the lower hose members (4) support the cable(s) (3) therein.

It is noted that the frame (1) may be left out in some cases, so that lines/cables (3) can be passed directly through an opening in a wall.

FIG. 3 shows a wall (7) provided with an opening eight, through which lines (9) are passed. The present bushing arrangement is built up of a gutter-shaped lower part (10), side members (11) forming side walls and a lid-shaped upper part (12), whilst in this specific case a gasket (13) and a mounting element (14) are furthermore provided. All this is shown in exploded view in FIG. 4 so as to provide a better understanding of the invention; in use, the various parts will be fitted together by means of bolts and nuts. The seal is in the form of plate-shaped members (15) in this case, which members are grouped round the lines (9) and which fill the remaining space in the bushing arrangement. Thus a liquid-tight and gastight bushing is provided, in which the lines (9) are bushed in a fire-resistant manner.

The sleeves (4), the hose members (4), which may or may not be massive, and the sheet material (15) are made with a rubbery material as a base, which material preferably has the following composition:

| EPDM-COMPOUND | |
|---|---|
| Ethylene-propylene terpolymer (EPDM) | 100 |
| Aluminium trihydrate A12(OH)3 | 135 |
| Polyammonium phosphate | 10-15 |
| Phosphate ester plasticiser | 5 |
| Interlaced graphite | 35 |
| Zinc oxide (ZnO) | 5 |
| Stearic acid | 1 |
| Polyethylene wax | 3 |
| Zinc salt of an unsaturated fatty acid | 3 |
| Deovule EG28 | 1.7 |
| Perkacit METS | 0.3 |
| Sulphur S80 | 2 |
| EVA-COMPOUND | |
| Ethyl-vinyl acetate copolymer | 100 |
| Aluminium trihydrate A12(OH)3 | 75 |
| Polyammonium phosphate | 10-15 |
| Interlaced graphite | 60 |
| Zinc stearate | 4 |
| Carboxylic acid amide | 5 |
| Polycarbo diimide | 2 |
| High-viscosity silicone polymer (SFR 100) | 10 |

1. A bushing arrangement for sealing passage of a cable, a pipe, a conduit or the like through an opening in a wall, which bushing arrangement comprises at least one seal arranged in the opening in the operative condition, which seal is at least substantially made of an elastic, fire-resistant material with a base of a cross-linkable polymer and an expandable agent in a quantity and composition such that the seal will expand in case of a fire, in such a manner that the opening in the wall will be sealed medium-tight the material of the seal has a foam structure comprising closed cells, wherein the cross-linkable polymer is composed of at least a rubbery linear polymer in the form of a copolymer of ethylene and vinyl acetate, with carbon peroxide sides being the vulcanization agent, and wherein the cross-linkable polymer is basic.

2. A bushing arrangement according to claim 1, wherein the cross-linkable polymer is composed of at least a rubbery linear polymer containing 10-20 wt. % of ammonium polyphosphate.

3. A bushing arrangement according to claim 1, wherein the expandable agent contains graphite in an amount of 5-25 wt. %.

4. A bushing arrangement according to claim 6, wherein said expandable agent contains graphite in an amount of 10-15 wt. %, preferably about 12.5 wt. %.

5. A bushing arrangement according to claim 1, wherein the seal is made up of sheet material.

6. A bushing arrangement according to claims 1, wherein the seal is made up of several hose members arranged in the opening in the wall.

7. A bushing arrangement according to claim 9, wherein said hose members are massive.

8. A bushing arrangement according to claim 9, wherein said hose members form sleeve means through each of which a cable, a pipe, a conduit or the like extends for the purpose of being passed through the opening in the wall.

9. A method for sealingly passing a cable, a pipe, a conduit and the like through an opening in the wall, in which a seal is arranged in the opening in the operative condition, which seal is at least substantially made of an elastic, fire-resistant material with a base of a cross-linkable polymer and an expandable agent in a quantity and composition such that the seal will expand in case of a fire, in such a manner that the opening in the wall will be sealed medium-tight, characterized in that the material of the seal is given a foam structure comprising closed cells.
